(19) United States
(12) Patent Application Publication
(10) Pub. No.: US 2007/0157447 A1
(43) Pub. Date: Jul. 12, 2007

(54) Method of improving the properties of a repaired component and a component improved thereby

(76) Inventor: Paul S. Prevey, Cincinnati, OH (US)

Correspondence Address: Mark F. Smith, 905 Ohio Pike, Cincinnati, OH, 45245, US

(21) Appl. No.: 11/650,807

(22) Filed: Jan. 8, 2007

Related U.S. Application Data
(60) Provisional application No. 60/757,231, filed on Jan. 9, 2006.

(51) Int. Cl. B23P 6/00

(52) U.S. Cl. 29/402.01; 29/407.01; 29/407.05

(57) ABSTRACT

A repaired component with improved material and mechanical properties and a method of improving the properties of a repaired component are provided. The repaired component comprises a body, a repaired area integral with the body, and an area of compressive residual stress wherein the area of compressive residual stress comprises at least a portion of the repaired area. One method for improving the fatigue performance, foreign object damage tolerance, and resistance to stress related failure mechanisms of a repaired component includes inducing a designed residual compressive stress distribution with a controlled amount of cold work in the repaired area to offset high-applied tensile stresses and stresses introduced as a result of the repair procedure as well as to improve the properties of the material added to the component during the repair.

This application claims the benefit of U.S. provisional application for patent 60/757,231 filed Jan. 9, 2006.

### BACKGROUND OF THE INVENTION

The present invention relates to a method for improving the fatigue performance and resistance to stress related failure mechanisms of repaired metallic components, and, more specifically, to a method of using residual compressive stresses to treat repaired components to improve fatigue performance, increase foreign object damage tolerance, and increase resistance to stress related failure mechanisms and a repaired aerospace component improved thereby.

The high vibratory and tensile stresses experienced by various moving or rotating components, such as those found in rotating turbo machinery in operation (particularly the blading members of the fan, compressor, and turbine stages in gas turbine engines), make such components susceptible to high cycle fatigue (HCF) and other stress related failure mechanisms such as stress corrosion cracking (SCC). HCF and SCC ultimately limit the service life of these components as prolonged exposure to such extreme operating conditions leads to the development of fatigue cracks in areas of the component subject to high operational stresses. The fatigue life of a component can be further limited by outside forces such as by the occurrence of foreign object damage (FOD). FOD locations act as stress risers or stress concentrators that hasten the development and propagation of fatigue cracks. FOD, such as encountered by turbo machinery, especially along the leading and trailing edges of blading members, significantly reduces the service life of components.

The potentially catastrophic effects of HCF and FOD require that fatigue-life limited components be monitored and periodically inspected for both cracks and FOD. Any damage or cracking found during inspection is assessed and the component is either retired from service due to the extent of the damage or else repaired and returned to service and subjected to continuing inspection intervals in order to monitor the propagation or recurrence of such damage or cracking. Additional damage mechanisms, such as the erosion of the tips of blading members from contact with sealing members in a turbine engine, may adversely impact the aerodynamic performance of an engine in addition to serving as an initiation site for fatigue cracks. This type of damage may also necessitate the removal and repair or replacement of the component. The inspection of components and the retirement of components from service adversely impact operation time and equipment cost, such as the flight readiness and maintenance costs, of the aircraft in which the components are employed.

In extreme cases, where damage significantly degrades the strength and fatigue performance of the component, the component may be redesigned to alter the vibrational characteristics of the component and thereby reduce the impact of damage on component performance. Alternatively, the component may be redesigned employing different materials with greater strength and/or fatigue performance. However, each of these alternatives is extremely expensive. Therefore repair or replacement of damaged components is preferred.

Depending on the nature and extent of the damage found during inspections, one of several methodologies may be employed to repair the component and restore it to its original configuration. Such methodologies are disclosed in U.S. Pat. Nos. 6,568,077, 6,787,740, and 5,701,669. While these methodologies may return a component to its original, pre-damage dimensions, they do not necessarily restore the desired material properties to the component, particularly in the repaired areas. As disclosed in U.S. Pat. No. 6,568,077, repair operations such as machining or welding may actually further degrade the material properties in areas adjacent to the repaired area by the introduction of undesirable tensile residual stresses and thermal effects thereby increasing the likelihood of failure in and around the repaired area. In addition, the introduction of new material through the repair process as well as the degradation of existing material may require the use of a heat treatment to impart the desired properties in the repaired area. However, heat treatments can be difficult to employ and may result in component distortion and other undesirable effects such as the formation of oxides in some titanium alloys. Further, U.S. Pat. No. 6,568,077 also teaches that the repaired area should be isolated from any areas of the component subject to maximum stress. Each of these conditions limits the applicability of the disclosed repair techniques.

The use of repair methodologies as an alternative to component replacement may be significantly increased if the fatigue strength, FOD tolerance, and resistance to stress related failure mechanisms of repaired components can be improved or restored to at least the as-manufactured condition, especially in the repaired areas. Common methods of improving the fatigue strength and foreign object damage tolerance of components, such as aerospace components, include the introduction of residual compressive stresses in critical areas susceptible to damage and fatigue failure such as the edges and tips of blading members. Introducing such residual compressive stresses improves the fatigue properties and foreign object damage tolerance of the component. This, in turn, decreases operation and maintenance costs and, such as for aerospace components, may increase the flight readiness of the aircraft in which the component is employed.

One method currently used to introduce beneficial compressive residual stresses in components, such as aerospace components, is laser shock peening (LSP) as disclosed in U.S. Pat. No. 6,541,733. LSP, for example, is used to impart compressive residual stresses in both sides of the integrally formed airfoil or blading members, thereby improving the material properties of the component. Further, U.S. Pat. Nos. 5,584,662 and 5,735,044 disclose the use of LSP in conjunction with repaired components to improve the material properties of the repaired component in the repaired area. Despite the demonstrated beneficial effects, LSP processing is expensive, labor intensive, and has a low rate of production as multiple treatments and operations are necessary to completely treat a given area.

Burnishing, also referred to as deep rolling, presents an equally effective, less expensive, and more time efficient alternative to LSP for inducing compressive residual stresses in the surface of a component. Burnishing, particularly ball burnishing as disclosed in U.S. Pat. Nos. 5,826,453, 6,415,486, and 6,622,570, has been shown to effectively increase the fatigue strength of components, such as airfoils and turbine disks, and substantially mitigate or eliminate stress induced failure mechanisms. Further, burnishing with a correspondingly low amount of cold work of less than about 5%, preferably less than about 3.5%, as taught in the aforementioned patents, has been shown to have beneficial effects on the mechanical and thermal stability of the induced residual compressive stresses. In addition, U.S. Pat. No. 6,926,970 B2 and U.S. Patent Application Publication No. US 2005/0224562 A1 teach that burnishing can be used in conjunction with a variety of welding techniques to produce a weld joint with improved fatigue and corrosion properties.

While the use of welding and brazing techniques to repair turbine engine components is known in the art, such techniques have not been used to repair areas subject to high-applied stress due to the inherent weakness of material introduced in the repair and the degradation of material surrounding the repair. Further, known techniques for improving the material properties of a repaired component are expensive, labor intensive, and time consuming. These drawbacks often offset or eliminate any economic benefits gained by repairing rather than replacing damaged components.

Accordingly, a need exists for an efficient and cost effective method of improving or restoring the fatigue performance, foreign object damage tolerance, and resistance to stress related failure mechanisms of repaired components subject to high-applied stresses.

### SUMMARY OF THE INVENTION

The present invention is directed to a method that satisfies the need for an efficient and cost effective method of improving or restoring the fatigue performance, foreign object damage tolerance, and resistance to stress related failure mechanisms of repaired components subject to high applied stresses. The method comprises identifying an area of a repaired component comprising at least a portion of a repaired area. The applied stresses experienced in the identified area are determined as well as the residual stresses introduced in the component during the repair operation. A compressive residual stress distribution with a controlled amount of cold work is designed to offset the applied and residual stresses in the repaired region. The compressive residual stress distribution is induced in the component thereby improving the strength, fatigue performance, FOD tolerance, and resistance to stress related failure mechanisms of the component.

In one embodiment of the method of the present invention the identified area comprises at least the entire repaired area.

In another embodiment of the present invention, compressive residual stresses are induced in the identified area by burnishing.

In another embodiment of the method of the present invention the compressive residual stress extends substantially through the thickness of the component.

In another embodiment of the method of the present invention the compressive residual stress extends through the thickness of the component.

In another form, the present invention comprises a blading member, such as a compressor, fan, or turbine blade of a turbine engine, comprising a body, a repaired area integral with the body, and an area of compressive residual stress. The area of compressive residual stress comprises at least a portion of the repaired area.

In one embodiment of this form of the invention, the area of compressive residual stress comprises at least the entire repaired area.

In another embodiment of the present invention, compressive residual stresses are induced in the identified area by burnishing.

In another embodiment of the invention, the area of compressive residual stress extends substantially through the thickness of the blading member.

In another embodiment of the invention, the area of compressive residual stress extends through the thickness of the blading member.

Accordingly, the present invention provides repaired components with improved material and mechanical properties through the application of residual compressive stress with a controlled amount of cold work and a method for producing the same. One advantage of the method of the present invention is that it reduces operation and maintenance costs for equipment subject to high operational stresses, such as steam turbines for power generation and gas turbine engines for use in aircraft propulsion and power generation, by facilitating the repair, rather than replacement, of damaged components regardless of the location of the damaged area relative to areas of the component subject to high-applied stresses.

Another advantage of the present invention is that it provides a repaired component with improved material and mechanical properties. The improved material and mechanical properties of the component facilitate the reintroduction of the repaired component into operational service with material and mechanical properties equivalent to or nearly equivalent to a new, as produced component.

Another advantage of the present invention is that it provides a method of repairing a component and a repaired component such that a costly redesign of the component and/or change of material is unnecessary.

Another advantage of the present invention is that it eliminates the need for a heat treatment following repair in order to restore the material properties.

Another advantage of the present invention is that it provides an efficient, relatively inexpensive and easily implemented method for restoring the material and mechanical properties of a repaired component.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing one embodiment of the repaired blading member of the present invention.

FIG. 2 is a flow diagram of the method of using residual stress to improve the fatigue life of a repaired component.

### DETAILED DESCRIPTION OF THE INVENTION

Metallic components subject to cyclic loading and high-applied stresses, such as the blading members of turbine engines, are susceptible to the development of fatigue cracks that can ultimately lead to the failure of the component. The occurrence of foreign object damage, such as along the leading and trailing edges of blading members of turbo machinery components, hastens the development of fatigue cracks as the damage locations act as stress risers or stress concentrators. Similarly, the abrasion and erosion of the tips of blading members as a result of contact with sealing members around the periphery of the engine and the erosion of blading members from contact with super-heated steam not only decreases the aerodynamic efficiency of the engine, but may also serve as initiation sites for fatigue cracks.

For an exemplary illustration, when a fatigue crack or similar damage is found in a blading member of a rotating turbo machinery component, the blading member is removed from service and, depending on an assessment of the damage, either repaired and returned to service or discarded and replaced. Repair procedures generally include machining or grinding away the damaged area to reduce the stress-concentrating effect of foreign object damage impacts. Where a significant amount of material has been removed, a welding or brazing process may be incorporated to “build up” new material in the damaged area. Similarly, a patch may be welded in place of the removed material. The repaired area is then machined to return the component to its pre-damage dimensions.

Due to the difficulties of repairing or restoring a damaged blading member to its pre-damaged configuration, which includes restoring the component to its pre-damage material strength as well as fatigue strength, highly conservative criteria are currently used to determine when a blading member may be adequately and safely repaired. Based on such criteria, if damage to a blading member occurs in a localized area subject to high-applied loads, the blading member will not be repaired and will be instead discarded as the repaired area may not have the desired fatigue properties to withstand operational stresses.

The current invention employs residual compressive stresses with a controlled amount of cold working to improve the material strength, fatigue strength, stress corrosion cracking resistance, and foreign object damage tolerance of repaired components, including weld-repaired components, such as the blading members of turbine engines used for aircraft propulsion and power generation applications. The improved material properties imparted in the repaired area by the method of the present invention facilitates the reintroduction of the repaired component into service even when the repaired area is subject to high applied stresses.

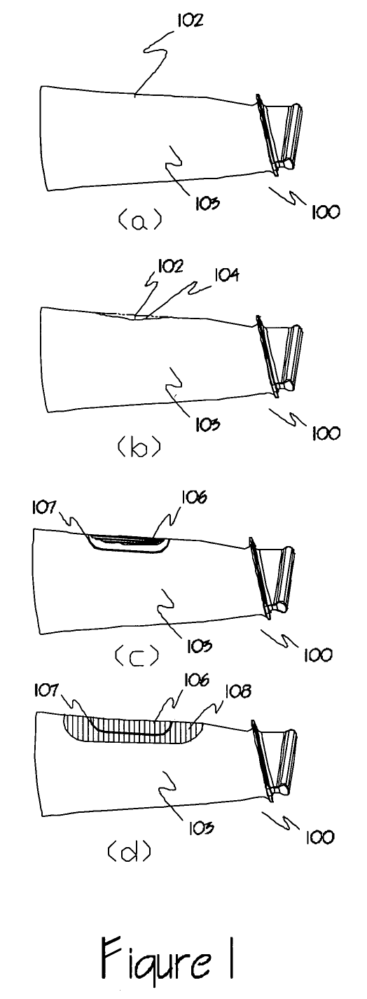

Referring now to FIG. 1, a series of drawings are shown exemplarily illustrating the repair process of a component 100 ultimately culminating in the component with improved properties shown in FIG. 1(d) that is a subject of the current invention. In a preferred embodiment of the invention, the component 100 is a blading member such as found in turbo machinery. As shown in FIG. 1(a) the blading member 100 has foreugn object damage 102 along the edge of the body 103 or airfoil portion of the blading member 100. Foreign object damage 102 may occur throughout the blading member byt is particularly detrimental to fatigue life when it occurs along the leading and trailing edges.

FIG. 1(b) shows one type of repair process in which material 104 surrounding the foreign object damage 102 is removed by machining or grinding. Material 104 is removed beginning at the edge of the blading member 100 and continuing inward, towards the center of the body 103, up to and including the depth of the foreign object damage 102 such that the damage is completely removed from the body 103. This eliminates the stress concentrating effect of the FOD 102 location and, as a result, reduces the likelihood that fatigue cracks will develop in this location.

Where the amount and depth of the material removed has been relatively small, the addition of new material is not needed. The repaired area is then treated with a surface enhancement to introduce residual compressive stresses to offset the tensile stresses introduced in the repair process and the applied stresses experienced during operation. The method for inducing residual compressive stresses in the repaired area is discussed further below.

Where a significant portion of material has been machined away in order to remove the foreign object damage, it becomes necessary to incorporate replacement material before residual compressive stresses are introduced. Therefore, in a next step, shown in FIG. 1(c), new material 106 is added in the form of a patch welded into place or else built up according to a welding or brazing process. The welding process used may be selected from the list including, but not limited to, gas welding, arc welding, resistance welding, thermite welding, laser welding, linear friction welding, friction stir welding and electron-beam welding. The new material 106 is then machined to restore the blading member 100 to the pre-damage dimensions. The repaired area 107 actually extends further into the body 103 than the new material 106 as the repaired area 107 includes material adjacent to the actual repair that has been detrimentally altered due to the welding and machining operations.

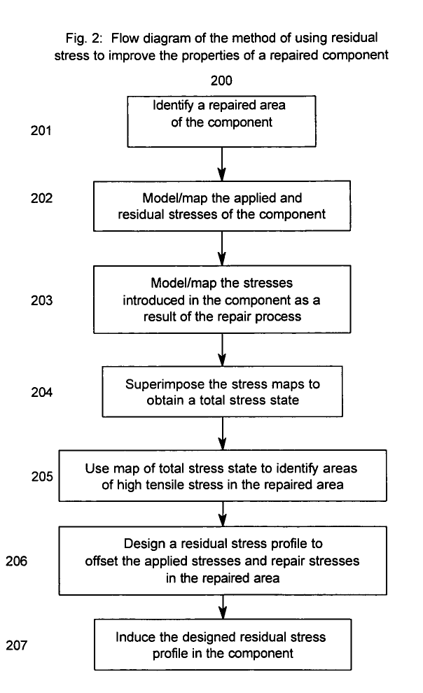

Finally, as shown in FIG. 1(d), the material properties of the repaired area 107 are improved through the introduction of residual compressive stresses with a controlled amount of cold work. The residual compressive stresses may be introduced in an area 108 that may include the entire repaired area 107 or may also include areas immediately adjacent to the repaired area. Alternatively, the residual compressive stresses may be introduced in a portion of the repaired area, such as along a weld seam or perimeter of the repaired area and the material adjacent thereto. The method of introducing the residual compressive stresses to improve the properties of the repaired blading member, which is a subject of the present invention, is carried out in a series of steps as shown in FIG. 2.

In a first step 201, an area of the component is identified which includes at least a portion of the repaired area. In a second step 202, a map and/or model of the applied and residual stresses acting on the component is created using conventional finite element analysis, direct measurement, or a combination thereof. In a third step 203, a map and/or model of the stresses introduced and/or degraded by the repair process is created using conventional techniques.

In a fourth step 204, a map and/or model of the total stress state is developed by combining the maps developed in steps two and three. This map is then used in a fifth step 205 where areas of high tensile stress in the repaired area of the component as a result of the applied stresses and/or the repair process are identified.

In a sixth step 206, a residual compressive stress distribution with a controlled amount of cold work is designed to offset the applied stresses and repair stresses in the repaired area. The residual compressive stress distribution is designed such that it will improve the material properties, such as material strength, fatigue performance, FOD tolerance, stress corrosion cracking resistance and resistance to stress related failure mechanisms of the material in the repaired area including original material adversely affected by the repair process and, when present, any new material contained in a patch, weld joint, or deposited through a welding or brazing operation.

The depth and magnitude of residual compressive stress and the amount of cold work are determined based upon the material from which the component is constructed, the operational and residual stresses experienced, and the location and depth of foreign object damage based on operational experience. By way of example, for titanium and nickel based-alloys, the desired compressive residual stress is generally in the range of about 50 to 150 ksi (thousands of pounds per square inch). The amount of cold working may be as low as about 3% for applications where thermal and mechanical stability of the residual compressive stress is desired. The amount of cold working need not be limited to a specific range but may be specifically optimized to yield a desired strength benefit depending on the specific material and application. If necessary, the designed residual stress distribution extends through the thickness of the blading member.

Finally, in a seventh step 207, the designed residual compressive stress distribution is induced in the component. The act of inducing may be accomplished by using a surface enhancement technique selected from the list including, but not limited to, burnishing, deep rolling, pinch peening, impact peening, coining, shot peening, and glass bead peening and/or combinations thereof. In a preferred embodiment, the act of inducing the designed residual compressive stress distribution is accomplished by burnishing.

Based on the foregoing, it should now be clear to one skilled in the art that the method disclosed can be used to improve the fatigue properties and resistance to stress related failure mechanisms of repaired components, such as, but not limited to, blading members, where the repair has been necessitated by damage, such as, for example, damage occurring along the leading edge, trailing edge or tip of a blading member. The method facilitates the use of repair methodologies such as the “blending” out of foreign object damage by machining and grinding as well as the use of weld repairs and the build up of blading members through welding techniques in areas of the component subject to high-applied stress. It should be understood that the method may be used on various repaired components, including but not limited to blading members such as blades and vanes used in the fan, compressor and turbine stages of gas turbine engines as well as integrally bladed components, such as integrally bladed rotors and disks for use in the same.

Accordingly, the present invention is a low cost alternative to currently available methods of improving the material properties of repaired components. The present invention reduces the operation and maintenance costs of machinery, such as but not limited to gas turbine engines by providing repaired components with improved fatigue properties, foreign object damage tolerance, and resistance to stress induced failure mechanisms and a method for improving the repaired component. The present invention facilitates the repair and reuse of components that would otherwise be discarded due to foreign object damage, or other similar damage, in areas of the component subject to high-applied stress.

While the method described herein constitutes a preferred embodiment of the invention, it is to be understood that the invention is not limited to the precise method and that changes may be made therein without departing from the scope of the invention.

What is claimed is:

1. A method for improving the properties of a repaired component comprising the acts of:
identifying an area of the component that comprises at least a portion of a repaired area of the component;
inducing compressive stresses in the identified area.

2. The method of claim 1 wherein the identified area includes undamaged material surrounding the repaired area adversely affected by the repair process.

3. The method of claim 1 further comprising the acts of:
determining the applied stress that the identified area is subject to during operation;
determining the residual stresses present in the identified area after the repair process has been completed; and
designing a residual stress distribution to be induced in the area of the repair to offset the effects of both the applied stresses and the residual stresses resulting from the repair process.

4. The method of claim 1 wherein the component has been repaired by removing the damaged area by machining or grinding.

5. The method of claim 4 further comprising the act of replacing the damaged area by joining new material to the component.

6. The method of claim 5 wherein the act of joining new material comprises welding a patch to the component.

7. The method of claim 5 wherein the act of joining new material comprises depositing successive layers of new material by welding or brazing.

8. The method of claim 5 wherein the act of joining consists of brazing, gas welding, arc welding, resistance welding, thermite welding, laser welding, linear friction welding, friction stir welding and electron-beam welding.

9. The method of claim 1 wherein the compressive stress is induced by a process selected from the list consisting of burnishing, deep rolling, pinch peening, impact peening, shot peening, glass bead peening, coining, and/or combinations thereof.

10. The method of claim 1 wherein the compressive stress is induced by burnishing.

11. A component with improved fatigue performance, increased tolerance of foreign object damage, and improved resistance to stress corrosion cracking, the blading member comprising:
a body;
at least one repaired area integral with said body; and
at least one area of compressive residual stress, said at least one area of compressive residual stress comprising a portion of a repaired area;
wherein said at least one area of compressive residual stress has been induced by burnishing.

12. The component of claim 11 wherein the area of compressive residual stress comprises the entire said repaired area.

13. The component of claim 11 wherein said at least one area of compressive residual stress extends through the thickness of said body.

14. The component of claim 11 wherein said at least one repaired area has been repaired by removing damage by machining or grinding.

15. The component of claim 11 wherein the component has been repaired by removing damage by machining or grinding, replacing the damage by joining new material to the component, and machining the new material to return the component to its original configuration.

16. The component of claim 15 wherein the act of joining comprises a process selected from the list consisting of brazing, gas welding, arc welding, resistance welding, thermite welding, laser welding, linear friction welding, friction stir welding and electron-beam welding.

17. The component of claim 15 wherein the act of joining new material comprises welding a patch to the component.

18. The component of claim 15 wherein the component has been repaired by depositing successive layers of material by welding or brazing.

19. The component of claim 15 is a blading member for use in turbo machinery.
